(19) United States
(12) Patent Application Publication
(10) Pub. No.: US 2018/0005157 A1
(43) Pub. Date: Jan. 4, 2018

(54) Media Asset Tagging

(71) Applicant: Disney Enterprises, Inc., Burbank, CA (US)

(72) Inventors: Nimesh Narayan, Los Angeles, CA (US); Jack Luu, Huntington Beach, CA (US); Alan Pao, Santa Monica, CA (US); Matthew Petrillo, Sandy Hook, CT (US); Anthony M. Accardo, Los Angeles, CA (US); Miquel Angel Farre Guiu, Bern (CH); Lena Volodarsky Bareket, Los Angeles, CA (US); Katharine S. Ettinger, Santa Monica, CA (US)

(21) Appl. No.: 15/199,717

(22) Filed: Jun. 30, 2016

(51) Int. Cl. G06Q 10/06; G06F 17/30

(52) U.S. Cl. CPC G06Q 10/06316; G06F 17/30038; G06Q 10/06395

(57) ABSTRACT

There are provided media asset tagging systems and method. Such a system includes a hardware processor, and a system memory storing a workflow management software code including a tagging application template and a multi-contributor synthesis module. The hardware processor executes the workflow management software code to provide a workflow management interface, to receive a media asset identification data and a workflow rules data, and to generate custom tagging applications based on the workflow rules data. The hardware processor further executes the workflow management software code to receive tagging data for the media asset, determine at least a first constraint for tagging the media asset, receive additional tagging data for, and determine at least a second constraint for tagging the media asset. The media asset is then tagged based on the tagging data and the additional tagging data, subject to the constraints.

### BACKGROUND

The extraction of descriptive metadata sufficient to characterize a media asset, such as a feature film or animation, for example, often requires the participation of human contributors having specialized knowledge. In addition, some of the metadata relied on to characterize a media asset may be extracted by automated processes, such as those using facial or object recognition software. Although tools for enabling collaboration among human contributors exist, those conventional tools are typically designed to passively process the inputs provided by each individual contributor. There remains a need for a solution enabling workflow management for the efficient extraction and synthesis of metadata for characterizing a media asset from a combination of automated and human sources.

### SUMMARY

There are provided systems and methods for media asset tagging, substantially as shown in and/or described in connection with at least one of the figures, and as set forth more completely in the claims.

### BRIEF DESCRIPTION OF THE DRAWINGS

FIG. 1 shows a diagram of a media asset tagging system, according to one implementation of the present disclosure;

FIG. 2 shows another exemplary implementation of a media asset tagging system;

FIG. 3 is a flowchart presenting an exemplary method for use by a media asset tagging system, according to one implementation of the present disclosure; and

FIG. 4 shows an exemplary workflow management interface provided by a media asset tagging system, according to one implementation of the present disclosure.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application addresses the challenges to collaboration described above, as well as analogous obstacles to successful workflow management. According to one implementation, a system and method according to the present inventive principles may be used to characterize a media asset utilizing tags based on metadata extracted from the media content by multiple human contributors and/or automated processes.

As disclosed in the present application, a media asset tagging system includes a workflow management software code including a tagging application template and a multi-contributor synthesis module. The workflow management software code, when executed by a hardware processor of the media asset tagging system, provides a workflow management interface enabling the workflow management software code to receive data identifying a media asset selected for tagging, as well as data for determining workflow rules. In addition, the workflow management software code utilizes the tagging application template to generate, based on the determined workflow rules, custom tagging applications for use by human contributors to extract metadata from the media asset.

The workflow management software code receives tagging data via one or more of the custom tagging applications, or in some instances from an automated media asset tagger or taggers as well. Based on the tagging data received, the workflow management software code can determine constraints for subsequent tagging data. In some implementations, the workflow rules may specify one or more quality assurance analyses of any of the received tagging data or the determined constraints. The workflow management software code can then utilize the multi-contributor synthesis module to tag the media asset based on the tagging data, subject to the determined constraints.

The collaboration and workflow management enabled by the systems and according to the methods disclosed in the present application can be applied across a wide variety of project types, including highly complex multidisciplinary projects. For example, as discussed in greater detail below, the present solution may be specifically applied to characterization of a media asset such as a video, feature film, or animation, using metadata based tags.

Alternatively, the present workflow management solution may be suitably adapted for application to the maintenance or upgrading of theme park assets, such as hotel accommodations, dining venue, rides, or shows, for example. Moreover, in some implementations, the present solution may be suitably adapted to provide workflow management for scheduling seasonal routing and/or relocation of cruise ships so as to substantially optimize passenger safety, comfort, and enjoyment. Coordination and management of the exemplary collaborative projects described above, as well as collaborative projects of many other types, can be enabled and enhanced through implementation of the systems and methods disclosed in the present application.

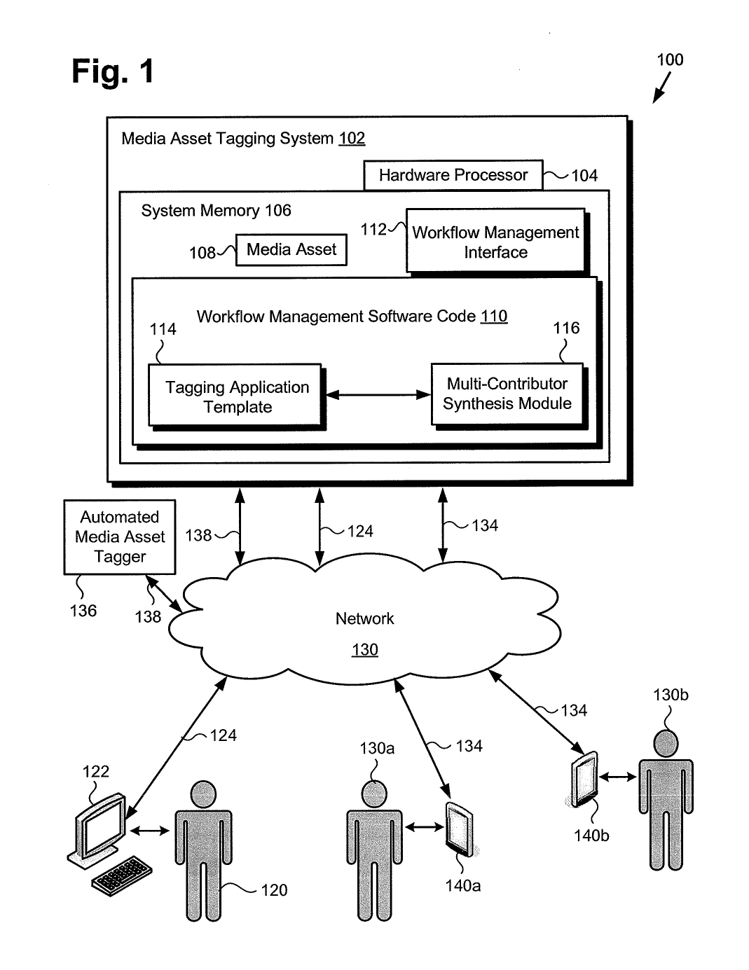

FIG. 1 shows a diagram of an exemplary media asset tagging system, according to one implementation. As shown in FIG. 1, media asset tagging system 102 is situated within collaboration environment 100 including communication network 130, management system 122 utilized by workflow manager 120, client systems 140a and 140b utilized by respective human contributors 130a and 130b, and automated media asset tagger 136.

Media asset tagging system 102 includes hardware processor 104, and system memory 106 storing workflow management software code 110 including tagging application template 114 and multi-contributor synthesis module 116. In addition, system memory 106 is shown to include media asset 108 and workflow management interface 112 provided by workflow management software code 110. Also shown in FIG. 1 are network communication links 134 interactively connecting client systems 140a and 140b with media asset tagging system 102 via communication network 130, as well as analogous network communication links 124 and 138 interactively connecting respective management system 122 and automated media asset tagger 136 with media asset tagging system 102.

According to the implementation shown in FIG. 1, workflow manager 120 may utilize management system 122 to interact with media asset tagging system 102 over communication network 130, for example to access and use workflow management interface 112. Moreover, and as discussed further below, human contributors 130a and 130b can use respective client systems 140a and 140b to interact with custom tagging applications generated by workflow management software code 110 using tagging application template 114. In one such implementation, media asset tagging system 102 may correspond to one or more web servers, accessible over a packet network such as the Internet, for example. Alternatively, media asset tagging system 102 may correspond to one or more servers supporting a local area network (LAN), or included in another type of limited distribution network.

It is noted that although FIG. 1 depicts media asset 108 and workflow management software code 110 including tagging application template 114 and multi-contributor synthesis module 116 as being mutually co-located in system memory 106, that representation is merely provided as an aid to conceptual clarity. More generally, media asset tagging system 102 may include one or more computing platforms, such as computer servers for example, which may be co-located, or may form an interactively linked but distributed system, such as a cloud based system, for instance. As a result, hardware processor 104 and system memory 106 may correspond to distributed processor and memory resources within media asset tagging system 102. Thus, it is to be understood that media asset 108 and workflow management software code 110 may be stored remotely from one another within the distributed memory resources of media asset tagging system 102.

It is further noted that although management system 122 is shown as a personal computer (PC), and client systems 140a and 140b are shown as mobile communication devices in FIG. 1, those representations are provided merely for exemplary purposes. In other implementations, management system 122 and/or client system 140a and/or client system 140b may be any type of user systems configured for communication with media asset tagging system 102, such as computer workstations, or personal communication devices such as smartphones or tablet computers, for example.

Media asset 108 is a media asset undergoing metadata extraction and tagging in a process guided and controlled by workflow management software code 110, executed by hardware processor 104. Media asset 108 may correspond to a variety of different types of media content. For example, media asset 108 may include media content in the form of video and/or audio content. Specific examples of media content that may be included in media asset 108 include feature films, animation, television programming, games, music, and educational content.

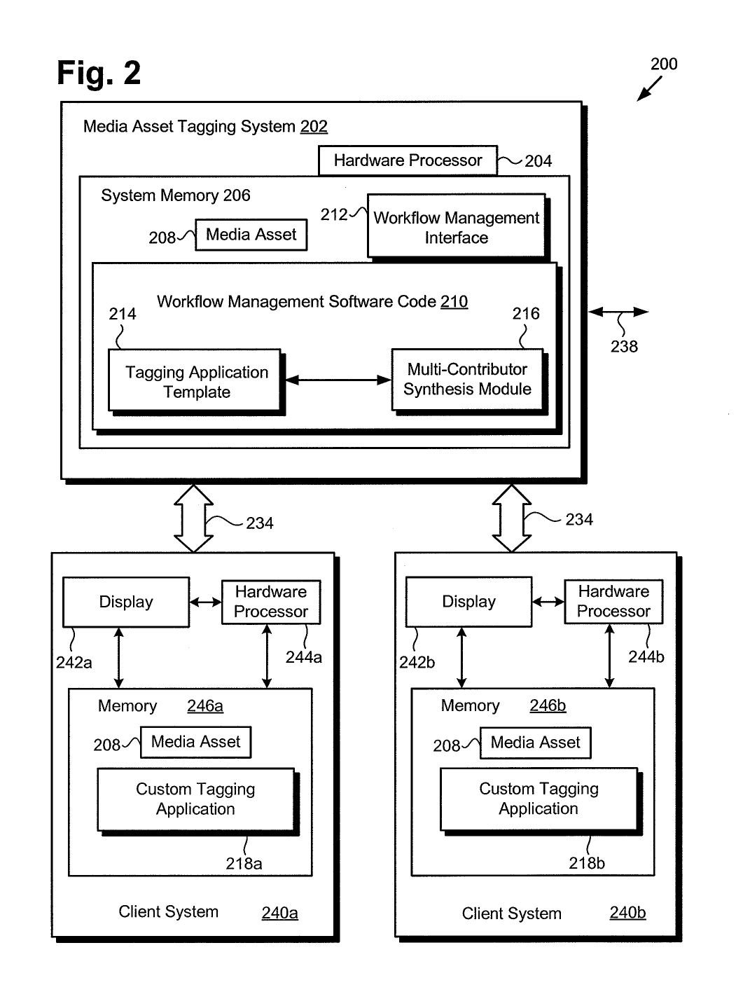

Referring to FIG. 2, FIG. 2 shows another exemplary implementation of a media asset tagging system as media asset tagging system 202. In addition to media asset tagging system 202, collaboration environment 200 in FIG. 2 includes client systems 240a and 240b interactively connected to media asset tagging system 202 over network communication links 234. FIG. 2 further shows communication link 238 interactively linking media asset tagging system 202 with an automated media asset tagger corresponding to automated media asset tagger 136, in FIG. 1. Also shown in FIG. 2 are multiple instantiations of media asset 208, as well as custom tagging applications 218a and 218b residing on respective client systems 240a and 240b.

As shown in FIG. 2, media asset tagging system 202 includes hardware processor 204, and system memory 206 storing media asset 208 and workflow management software code 210 including tagging application template 214 and multi-contributor syntheses module 216. In addition, system memory 206 is shown to include workflow management interface 212 provided by workflow management software code 210. As further shown in FIG. 2, client system 240a includes display 242a, hardware processor 244a, and memory 246a storing media asset 208 and custom tagging application 218a, while client system 240b includes display 242b, hardware processor 244b, and memory 246b storing media asset 208 and custom tagging application 218b.

Network communication links 234 and 238, and media asset tagging system 202 including hardware processor 204 and system memory 206 correspond in general to network communication links 134 and 138, and media asset tagging system 102 including hardware processor 104 and system memory 106, in FIG. 1. In addition, workflow management software code 210 including tagging application template 214 and multi-contributor syntheses module 216, in FIG. 2, corresponds in general to workflow management software code 110 including tagging application template 114 and multi-contributor syntheses module 116, in FIG. 1. In other words, workflow management software code 210, tagging application template 214, and multi-contributor syntheses module 216 may share any of the characteristics attributed to corresponding workflow management software code 110, tagging application template 114, and multi-contributor syntheses module 116 in the present application.

Client systems 240a and 240b correspond in general to client systems 140a and 140b, respectively, in FIG. 1. According to the exemplary implementation shown in FIG. 2, custom tagging application 218a is located in memory 246a of client system 240a and custom tagging application 218b is located in memory 246b of client system 240b, custom tagging applications 218a and 218b having been received from media asset tagging system 202 via network communication links 234. In one implementation, network communication links 234 corresponds to transfer of custom tagging applications 218a and 218b over a packet network, for example. Once transferred, for instance by being downloaded over network communication links 234, custom tagging applications 218a and 218b may be persistently stored in respective memories 246a and 246b, and may be executed locally on respective client systems 240a and 240b by respective hardware processors 244a and 244b.

Hardware processors 244a and 244b may be the central processing units (CPUs) for respective client systems 240a and 240b, for example, in which role hardware processors 244a and 244b run the respective operating systems for client systems 240a and 240b, and execute respective custom tagging applications 218a and 218b. Displays 242a and 242b may take the form of liquid crystal displays (LCDs), light-emitting diode (LED) displays, organic light-emitting diode (OLED) displays, or any suitable display screens that perform a physical transformation of signals to light.

In the exemplary implementation represented in FIG. 2, human contributors using client systems 240a and 240b, such as respective human contributors 130a and 130b, in FIG. 1, can utilize respective custom tagging applications 218a and 218b to send tagging data for media asset 208 to media asset tagging system 202.

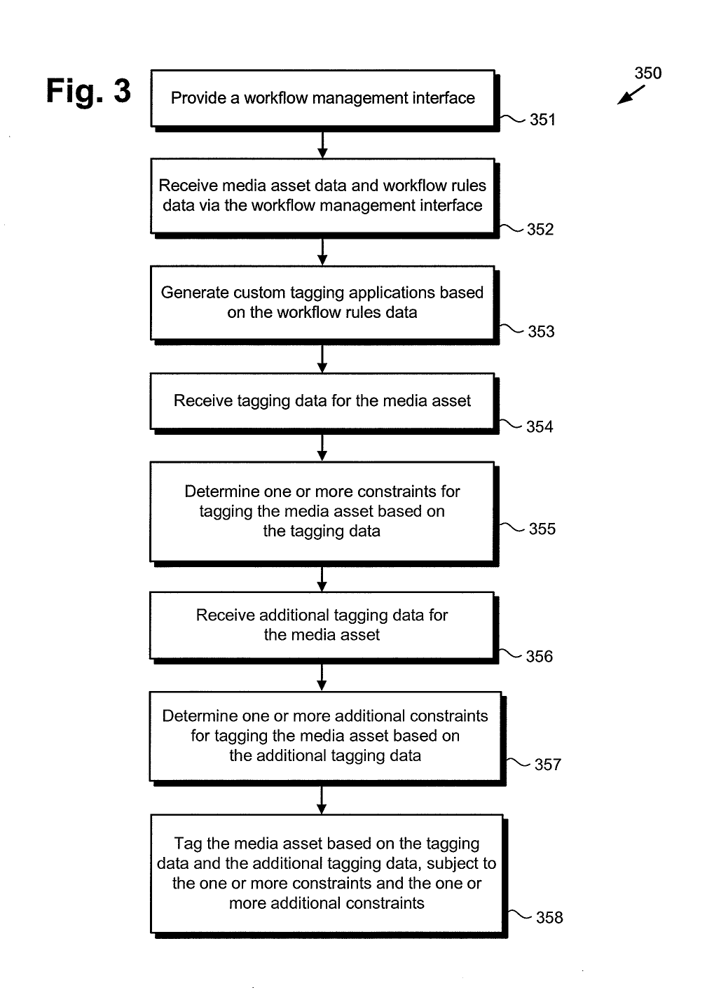

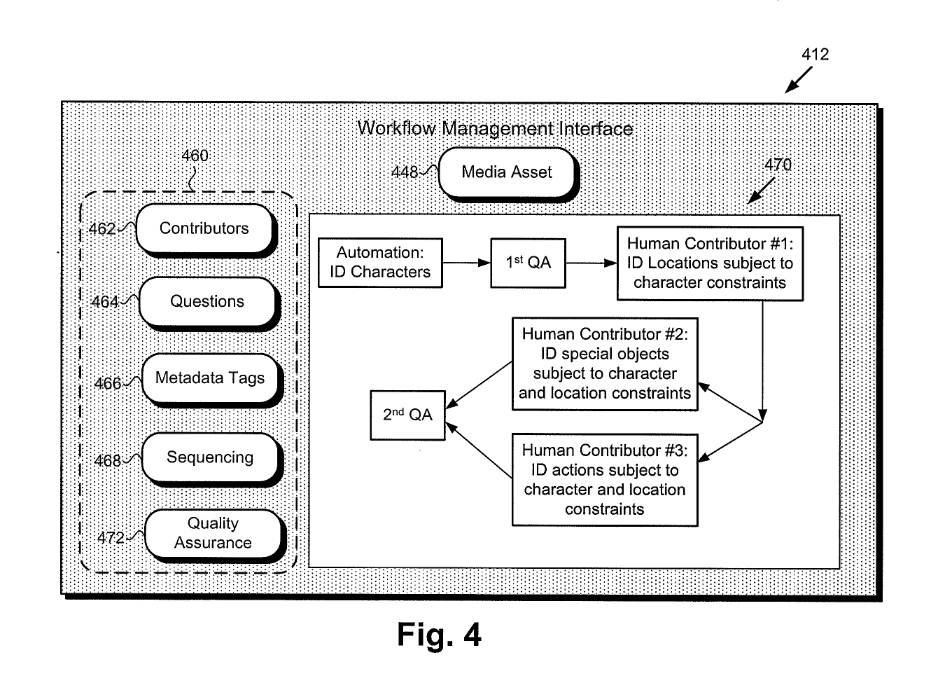

Media asset tagging system 102/202 in FIGS. 1 and 2 will be further described by reference to FIGS. 3 and 4. FIG. 3 shows flowchart 350 outlining an exemplary method for use by a media asset tagging system, while FIG. 4 shows exemplary workflow management interface 412 provided by a media asset tagging system, according to one implementation.

Referring to flowchart 350, with further reference to FIGS. 1, 2, and 4, flowchart 350 begins with providing workflow management interface 112/212/412 (action 351). Workflow management interface 112/212/412 may be provided by workflow management software code 110/210 of media asset tagging system 102/202, executed by hardware processor 104/204. As noted above, workflow management interface 112/212/412 may be accessed and used by workflow manager 120, utilizing management system 122 and communication network 130.

Referring to FIG. 4, FIG. 4 shows a specific example of workflow management interface 412, which may correspond to either or both of workflow management interfaces 112 and 212 in respective FIGS. 1 and 2. As shown in FIG. 4, workflow management interface 412 may include a number of predetermined categories or fields to be populated and/or modified by workflow manager 120. For example, workflow management interface 412 includes media asset field 448 for identifying media asset 108/208 undergoing metadata extraction and tagging. In addition, workflow management interface 412 includes categories of workflow rules 460 for governing the metadata extraction and tagging of media asset 108/208.

Workflow rules 460 may be selected or modified by workflow manager 120, via workflow management interface 412, to produce workflow 470 specifying the processing events used to extract metadata from and tag media asset 108/208, as well as the sequencing in which those processing events occur. Workflow 470 will be described more completely below.

As shown in FIG. 4, workflow rules 460 include rules specifying what automated or human contributors 462 will participate in the metadata extraction and tagging of media asset 108/208, what questions 464 will be posed to those respective contributors, and what metadata tags 466 will be available for those respective contributors to use in tagging media asset 108/208. In addition, rules 460 may include rules specifying sequencing 468, i.e., the order in which contributors 462 will participate in the tagging. For example, two automated processes and/or human contributors may participate sequentially, or may work in parallel. Rules 460 may also include rules specifying the type or types of quality assurance (QA) 472 analysis to be performed during metadata extraction and tagging of media asset 108/208, as well as the number of times such QA is to be performed.

Flowchart 350 continues with receiving media asset identification data and workflow rules data via workflow management interface 112/212/412 (action 352). Media asset identification data and workflow rules data may be received by workflow management software code 110/210, executed by hardware processor 104/204. Referring to FIG. 1, media asset identification data and workflow rules data may be received from management system 122 operated by workflow manager, and may be communicated to workflow management software code 110 of media asset tagging system 102 over network communication links 124.

The media asset identification data received by workflow management software code 110/210 may populate media asset field 448 of workflow management interface 112/212/412, and may be used to identify media asset 108/208. The media asset rules data received by workflow management software code 110/210 may be used to select among or modify rules 460 for producing workflow 470.

Flowchart 350 continues with generating custom tagging applications 218a and 218b based on the workflow rules data (action 353). Generation of custom tagging applications 218a and 218b can be performed by workflow management software code 110/210, executed by hardware processor 104/204, and using tagging application template 114/214.

By way of example, human contributors 130a and 130b may each have specialized knowledge regarding different features of media asset 108/208. Consequently, custom tagging application 218a generated for use by human contributor 130a may be different from custom tagging application 218b generated for use by human contributor 130b. That is to say, for example, workflow manager 120 may utilize workflow management interface 112/212/412 to identify different questions 464 and to make available different metadata tags 466 for inclusion in respective custom tagging applications 218a and 218b.

As a specific example, where media asset 108/208 is a feature film, human contributor 130a may have specialized knowledge of locations appearing in the film, while human contributor 130b may have specialized knowledge about special objects, such as weapons or vehicles, used in the film. Under those circumstances, the questions and metadata tags included in custom tagging application 218a may be selected or composed by workflow manager 120 to elicit location information from human contributor 130a. Analogously, the questions and metadata tags included in custom tagging application 218b may be selected or composed by workflow manager 120 to elicit special object information from human contributor 130b.

Flowchart 350 continues with receiving a first tagging data for media asset 108/208 (action 354). The first tagging data may be received by workflow management software code 110/210, executed by hardware processor 104/204, via automated media asset tagger 136, or from human contributors 130a or 130b via respective custom tagging applications 218a and 218b.

Referring to FIG. 4, the source or sources of the first tagging data is/are determined according to workflow 470 produced by workflow manager 120 using workflow management interface 112/212/412. As a specific example consistent with workflow 470, media asset 108/208 may include video depicting various characters, locations in which those characters appear, special objects used by the characters, and actions engaged in by the characters. Under such circumstances in general, the first tagging data may include one or more of character identification metadata, location identification metadata, special object identification metadata, and action identification metadata for the respective characters, locations, special objects, or actions depicted in the video.

However, the particular metadata extraction and tagging process governed by workflow 470 relies on tagging data inputs from a combination of automated and human contributors, and is specific about the sequence in which those contributors participate. According to workflow 470, for example, contributors 462 include automated media tagger 136 and human tagging contributors corresponding in general to human contributors 130a and 130b. In addition, workflow 470 specifies that the first tagging data is to be tagging metadata identifying characters in media asset 108/208, and that the first tagging data be received from automated media tagger 136.

It is noted that according to the exemplary media asset tagging process described by workflow 470, automated media tagger 136 is tasked with identifying characters appearing in media asset 108/208. In that instance, automated media tagger 136 may utilize facial detection or recognition software to automatically identify characters in media asset 108/208. However, in other implementations, media asset tagging system 102/202 may utilize other types of automated media taggers to identify other attributes or characteristics of media asset 108/208. Thus, in other implementations, automated media asset tagger 136 may utilize object recognition software, computer vision, or natural language processing, for example.

Flowchart 350 continues with determining one or more constraints for tagging media asset 108/208 based on the first tagging data (action 355). Determination of the one or more constraints based on the first tagging data may be performed by workflow management software code 110/210, executed by hardware processor 104/204.

For example, and returning to the case in which media asset 108/208 includes video, and the first data provided by automated asset tagger 136 identifies characters appearing in the video, one or more constraints may be determined based on those characters. For instance, the cast of characters identified by automated media tagger 136 may be known to have appeared in video content including some locations but not others. That information may be available to workflow management software code 110/210 from a media asset knowledge base accessible over communication network 130 (knowledge base not shown in the present figures). Workflow management software code 110/210 may use such information to constrain subsequent identification of locations within media asset 108/208 by preventing a subsequent automated or human contributor from selecting a location tag that does not correspond to one of the subset of locations corresponding to the cast of characters identified by the first data.

Similarly, special object tags and/or action tags utilized by subsequent automated or human contributors may be constrained based on special objects and or actions known to correspond to the cast of characters identified by the first tagging data. Where the constraint or constraints are imposed upon human contributors, for example, custom tagging application 218a and/or 218b generated by action 353 may be updated based on the one or more constraints determined by action 355. Such updating of custom tagging application 218a and/or 218b may be performed by workflow management software code 110/210, executed by hardware processor 104/204.

Flowchart 350 continues with receiving additional tagging data for media asset 108/208 (action 356). The additional tagging data may be received by workflow management software code 110/210, executed by hardware processor 104/204. Like the first tagging data received in action 354, the additional tagging data may be received via automated media asset tagger 136, or from human contributors 130a or 130b via respective custom tagging applications 218a and 218b, and may be communicated to workflow management software code 110/210 over one of network communication links 138 and 134.

Referring to FIG. 4, the source or sources of the additional tagging data is/are determined according to workflow 470 produced by workflow manager 120 using workflow management interface 112/212/412. Continuing with the exemplary use case in which media asset 108/208 includes video depicting various characters, locations, special objects, and actions, as described above, the additional tagging data may include one or more of character identification metadata, location identification metadata, special object identification metadata, and action identification metadata for a respective character, location, special object, or action depicted in the video.

According to workflow 470, in addition to an automated media tagger providing the first character tagging data, contributors 462 include first, second, and third human contributors providing additional location tagging data, special object tagging data, and action tagging data, respectively. In addition, workflow 470 specifies that the first tagging data received from automated media asset tagger 136 identifying characters in media asset 108/208 be used as an input to locations tagging performed by the first human contributor. That locations tagging performed by the first human contributor is used, in turn, as an input to the special objects and actions tagging performed in parallel by the second and third human contributors. In other words, the additional tagging data may be generated based on the first tagging data.

It is noted that although according to workflow 470, the first tagging data is received from an automated media asset tagger, while the additional tagging data is received from human contributors via custom tagging applications corresponding to custom tagging applications 218a and 218b, that specific workflow organization is merely exemplary. Other workflows implemented using media asset tagging system 102/202 may specify receipt of a first tagging data via a custom tagging application from a human contributor, followed by receipt of additional tagging data from a combination of one or more additional human contributors and/or one or more automated media asset taggers. Thus, the additional tagging data for media asset 108/208 may include a second tagging data received via an automated media asset tagger or a custom tagging application, as well as a third, fourth, or more tagging data each received via an automated media asset tagger or a respective custom tagging application.

Flowchart 350 continues with determining one or more additional constraints for tagging media asset 108/208 based on the additional tagging data (action 357). Determination of the one or more additional constraints based on the additional tagging data may be performed by workflow management software code 110/210, executed by hardware processor 104/204.

Returning yet again to the case in which media asset 108/208 includes video, the first data provided by automated asset tagger 136 identifies a cast of characters appearing in the video, and additional tagging data provided by a first human contributor identifies one or more locations corresponding to that cast of characters, one or more additional constraints may be determined based on those locations. For instance, some special objects may be known to appear, and/or some actions may be known to occur, in some locations but not in others. As noted above, such information may be available to workflow management software code 110/210 from a media asset knowledge base accessible over communication network 130. Workflow management software code 110/210 may use that information to constrain subsequent identification of special objects and/or actions within media asset 108/208 by preventing subsequent automated or human contributors from selecting a special object or action tag that does not correspond to one of the subset of special objects or actions corresponding to the identified locations, or to the identified cast of characters.

In workflow implementations in which the additional constraint or constraints are imposed upon human contributors, custom tagging application 218a and/or 218b generated by action 353 may be updated based on the one or more additional constraints determined by action 357. Such updating of custom tagging application 218a and/or 218b may be performed by workflow management software code 110/210, executed by hardware processor 104/204.

Moreover, and as shown by workflow 470, in some implementations, the constraints determined by action 357 may be imposed on more than one tagging contributor working in parallel. For example, in exemplary workflow 470, the second human contributor generates the additional special objects tagging data substantially concurrently with generation of the additional actions tagging data by the third human contributor.

Flowchart 350 may conclude with tagging media asset 108/208 based on the first tagging data and the additional tagging data, subject to the one or more constraints determined based on the first tagging data, and the one or more additional constraints (action 358). Tagging of media asset 108/208 may be performed by workflow management software code 110/220, executed by hardware processor 104/204, and using multi-contributor synthesis module 116/216.

In one implementation, for example, multi-contributor synthesis module 116/216 may be utilized by workflow management software code 110/210 to filter the tagging data received from all contributors, i.e., automated media asset tagger or taggers 136 and all human contributors including human contributors 130a and 130b, using the constraints determined based on that tagging data. As a result, a comprehensive and consistent set of metadata tags may be applied to media asset 108/208 that characterizes many or substantially all of its attributes.

Although not included in the outline provided by exemplary flowchart 350, as shown by workflow management interface 412, in FIG. 4, in some implementations, media asset tagging may further include one or more iterations of QA analysis. For example, workflow manager 120 can select or modify rules governing quality assurance 472 from among workflow rules 460. Consequently, QA can be performed one or more times during workflow 470, and may be performed based on the workflow rules data received from workflow manager 120 in action 352. QA may be performed by workflow management software code 110/210, executed by hardware processor 104/204, and may include QA analysis of one or more of the first tagging data, the constraint or constraints determined based on the first tagging data, the additional tagging data, and the one or more additional constraints.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A media asset tagging system comprising:
a hardware processor;
a system memory having stored therein a workflow management software code including a tagging application template and a multi-contributor synthesis module;
wherein the hardware processor is configured to execute the workflow management software code to:
provide a workflow management interface;
receive a media asset identification data and a workflow rules data via the workflow management interface;
generate, using the tagging application template, a plurality of custom tagging applications based on the workflow rules data;
receive a first tagging data for the media asset;
determine at least a first constraint for tagging the media asset based on the first tagging data;
receive an additional tagging data for the media asset;
determine at least a second constraint for tagging the media asset based on the additional tagging data;
tag the media asset, using the multi-contributor synthesis module, based on the first tagging data and the additional tagging data, subject to the at least first constraint and the at least second constraint.

2. The media asset tagging system of claim 1, wherein the additional tagging data is generated based on the first tagging data.

3. The media asset tagging system of claim 1, wherein the hardware processor is further configured to execute the workflow management software code to perform a quality assurance analysis of at least one of the first tagging data, the at least first constraint, the additional tagging data, and the at least second constraint.

4. The media asset tagging system of claim 3, wherein the quality assurance analysis is performed based on the workflow rules data.

5. The media asset tagging system of claim 1, wherein at least one of the first tagging data and the additional tagging data is received via an automated media asset tagger.

6. The media asset tagging system of claim 1, wherein at least one of the first tagging data and the additional tagging data is received via one of the plurality of custom tagging applications.

7. The media asset tagging system of claim 1, wherein at least one of the plurality of custom tagging applications is updated based on the at least first constraint.

8. The media asset tagging system of claim 1, wherein the additional tagging data includes a second tagging data and a third tagging data, each of the second tagging data and the third tagging data being received via one of:
an automated media asset tagger; and
one of the plurality of custom tagging applications.

9. The media asset tagging system of claim 8, wherein the second tagging data and the third tagging data are generated substantially concurrently.

10. The media asset tagging system of claim 1, wherein the media asset comprises video, and wherein one of the first tagging data and the additional tagging data includes at least one of character identification metadata, location identification metadata, special object identification metadata, and action identification metadata for a respective character, location, special object, or action depicted in the video.

11. A method for use by a media asset tagging system including a hardware processor and a system memory having a tagging application template and a multi-contributor synthesis module stored therein, the method comprising:
providing, using the hardware processor, a workflow management interface;
receiving, via the workflow management interface, a media asset identification data and a workflow rules data;
generating, using the tagging application template executed by the hardware processor, a plurality of custom tagging applications based on the workflow rules data;
receiving, using the hardware processor, a first tagging data for the media asset;
determining, using the hardware processor, at least a first constraint for tagging the media asset based on the first tagging data;
receiving, using the hardware processor, an additional tagging data for the media asset;
determining, using the hardware processor, at least a second constraint for tagging the media asset based on the additional tagging data;
tagging the media asset, using the multi-contributor synthesis module executed by the hardware processor, based on the first tagging data and the additional tagging data, subject to the at least first constraint and the at least second constraint.

12. The method of claim 11, wherein the additional tagging data is generated based on the first tagging data.

13. The method of claim 11, further comprising performing a quality assurance analysis, using the hardware processor, of at least one of the first tagging data, the at least first constraint, the additional tagging data, and the at least second constraint.

14. The method of claim 13, wherein the quality assurance analysis is performed based on the workflow rules data.

15. The method of claim 11, wherein at least one of the first tagging data and the additional tagging data is received via an automated media asset tagger.

16. The method of claim 11, wherein at least one of the first tagging data and the additional tagging data is received via one of the plurality of custom tagging applications.

17. The method of claim 11, wherein at least one of the plurality of custom tagging applications is updated based on the at least first constraint.

18. The method of claim 11, wherein the additional tagging data includes a second tagging data and a third tagging data, each of the second tagging data and the third tagging data being received via one of:
an automated media asset tagger; and
one of the plurality of custom tagging applications.

19. The method of claim 18, wherein the second tagging data and the third tagging data are generated substantially concurrently.

20. The method of claim 11, wherein the media asset comprises video, and wherein one of the first tagging data and the additional tagging data includes at least one of character identification metadata, location identification metadata, special object identification metadata, and action identification metadata for a respective character, location, special object, or action depicted in the video.
